(19) United States
(12) Patent Application Publication
(10) Pub. No.: US 2007/0210472 A1
(43) Pub. Date: Sep. 13, 2007

(54) Process For Manufacturing Elements, Such As Vanes For Thrust Reverser Cascades, By Molding A Composite

(76) Inventors: Alain D'Inca, Briis S/Forge (FR); Caroline Morel, Clamart (FR); Jean-Pierre Jumel, Croissy Sur Seine (FR)

Correspondence Address: YOUNG & THOMPSON, 745 SOUTH 23RD STREET, 2ND FLOOR, ARLINGTON, VA, 22202, US

(21) Appl. No.: 11/578,303

(22) PCT Filed: Apr. 19, 2005
(86) PCT No.: PCT/FR05/00942

§ 371 Date: Oct. 13, 2006

(30) Foreign Application Priority Data
Apr. 27, 2004 (FR) 0404442

(51) Int. Cl. B27N 3/00

(52) U.S. Cl. 264/108; 264/113; 264/122; 264/161

(57) ABSTRACT

A method for production of discontinuous elements, such as thrust-reverser cascade vanes, from a continuous premix. The premix (8), containing at least one layer of unidirectional continuous fibres (11) and a filler (9), is arranged in the large dimension of the elements (X-X1). The semi-finished product thus obtained is made up of parts (12a-12c) which will provide the elements and sheets of material (13a,13b) which will be subsequently removed.

The subject of the present invention is a process for manufacturing a series of juxtaposed elements separated from one another over at least part of their length, which elements may for example be the vanes or blades of a thrust reverser cascade or those of a compressor rotor, or rotor portion, for an aircraft engine.

At the present time, reverser cascades are either made of machined metal, and therefore relatively heavy, which is a major drawback in the aeronautical field, or manufactured from a composite, which is lighter, but at the cost of unsatisfactory lay-up techniques. This is because such techniques do not make it possible to obtain aerodynamic profiles which change really smoothly and they require many manual operations that result in a high production cost.

The manufacture of such elements by the compression molding of composites, of the type of those mentioned later in regard to the fill material used in the premix according to the invention, would constitute an economical solution suitable for producing aerodynamic profiles which change really smoothly, but the attempts made hitherto have not been satisfactory as they result in products not having the desired mechanical strength.

However, a process has now been discovered that remedies this drawback, which process consists:

a) in using, as raw material, a premix combining, in a substantially homogeneous volume ratio, on the one hand, at least one layer of unidirectional continuous resin-preimpregnated fibers and, on the other hand, a fill material;

b) in using, as equipment, a die-forming tool comprising a die and a cover defining together a series of cavities, the shape of which, which has a long dimension and a small cross section in the plane perpendicular to said long dimension, corresponds to that of the expected elements, said cavities communicating with one another via a passage provided between each pair of cavities, said passages having a volume such that, during the die-forming, most of the premix in the passages is forced to flow into the cavities;

c) in placing said premix in said tool in such a way that it affects said series of cavities and, by orienting it so that, in line with each cavity, there are fibers that extend along said long dimension and belonging to said at least one layer;

d) in die-forming said premix thus placed, resulting in the formation of a series of juxtaposed elements that are enriched with fill material compared with the volume ratio of the initial premix, which elements are joined together by webs of material, called here “mesh grounds”, which correspond to said passages and are depleted in fill material compared with the volume ratio of the initial premix; and

e) in eliminating said mesh grounds.

Discontinuous elements are thus manufactured from a continuous premix.

The expression “substantially homogeneous” used in the present description and the claims does not exclude the possibility, in places, for particular arrangements to be made in the premix in order to take into account, for example, geometrical differences in the expected elements. In any case, the differences in homogeneity that result therefrom bear no comparison with those observed, after the die-forming operation, between, on the one hand, those parts of the semifinished product that will constitute the expected elements and, on the other hand, the mesh grounds.

Compression molding in a multi-impression mold usually consists in placing feed material in each of the impressions or cavities defined by the mold, in softening the material by heating it, and in closing the two mold parts: the pressure exerted forces the material to match the shape of the cavities and, to avoid having to supply precisely the quantity of feed material that is strictly necessary and sufficient in order to fill each cavity, mold is charged with a slight excess of feed material and leakage channels or passages are provided for the excess material, which channels or passages may also provide communication between cavities.

The presence of such passages results in the molded elements being connected by bridges or webs of material.

Although in the conventional technique recalled above, the passages are used essentially to allow the excess material to escape from the cavities, in contrast, according to the invention, it is essentially the excess material of the passages that escapes into the cavities. Thus, the premix which is located in the passages and which flows serves as a complementary reservoir for filling the adjacent cavities. However, the premix does not flow homogeneously—it is the fill material that flows, the fibers themselves remaining trapped in the passages, possibly with residual fill material. These fibers and the residual fill material form, after the die-forming operation, the mesh grounds. After step d), a semifinished product is therefore obtained in which the expected elements are linked together by said mesh grounds, which can then be removed by water-jet cutting or by machining.

Under the effect of the die-forming, the fibers of said layer or layers of unidirectional continuous fibers are splayed out, in order to match the shape of the semifinished product, by being distributed in a substantially homogeneous manner. This makes it possible to provide, right from the production of the premix, the fiber density that will be found in the expected elements. This results in a predictable degree of reinforcement of said expected elements.

In general, a premix will be used in which said layer or layers of unidirectional continuous fibers each consist of several superposed plies of such fibers oriented in the same direction and, under the effect of the die-forming, the fibers of at least one of said plies will be forced to be accommodated between the splayed-out fibers of another of said plies. Thus, despite the splaying-out of the fibers under the effect of the die-forming operation, a certain continuity in the parallel juxtaposition of the fibers will be preserved, at the cost of a thinning of the superposition of plies, this all taking place as if the plies of unidirectional continuous fibers were organized to channel the fill material while it is flowing.

In a first method of implementing the process according to the invention, applied to the manufacture of a series of parallel juxtaposed elements, for example thrust reverser cascade vanes, the premix, used in step c), incorporates several layers of unidirectional continuous fibers, which layers make between them a substantially zero angle, and is oriented in such a way that the fibers of said layers are substantially parallel to the long dimension of the cavities of said series of cavities.

In a second method of implementing the process according to the invention, applied to the manufacture of a series of juxtaposed radiating elements, for example compressor rotor vanes, the process consists in using a premix incorporating several layers of unidirectional continuous fibers, at least some of said layers making between them an angle such that, in step c), there are, in line with each cavity, fibers extending along the long dimension of said cavity and belonging to at least one of said layers.

In one practical embodiment of the invention, said layer or layers of unidirectional continuous fibers are produced from one or more plies having, individually, a thickness of between 1/10 mm and 1 mm.

The fill material may be in any form, for example in the form of granules, mats, filled resin or fragments of at least one ply of unidirectional preimpregnated fibers, or of a combination of them. The fragments may come from a ply identical to a constituent ply of said at least one layer of unidirectional continuous fibers, or they may come from a ply that differs from the constituent ply or plies by its qualitative and/or quantitative composition and/or by its thickness.

The resin impregnating the unidirectional continuous fibers is generally a thermosetting resin. It may also be envisaged to use a thermoplastic resin.

In practice, before the die-forming, said premix is in the form of a sheet having a substantially constant thickness and the dimensions of which in the plane perpendicular to said thickness are substantially equal to the dimensions, in this same plane, of the region of the tool defining the coverage of the series of elements to be obtained.

The scope of the invention covers not only the manufacturing process described above, but also the semifinished product resulting from the implementation of steps a), b), c) and d) of said process. In such a semifinished product, the mesh grounds will generally have a thickness of between about 3/10 mm and 1 mm.

The scope of the invention also covers the structures incorporating the elements manufactured by implementing the process described, especially elements each having an aerodynamic profile, such as the cascade vanes for an aircraft engine thrust reverser and compressor rotors or rotor portions.

The invention will be better understood on reading the following description given with reference to the appended drawings in which:

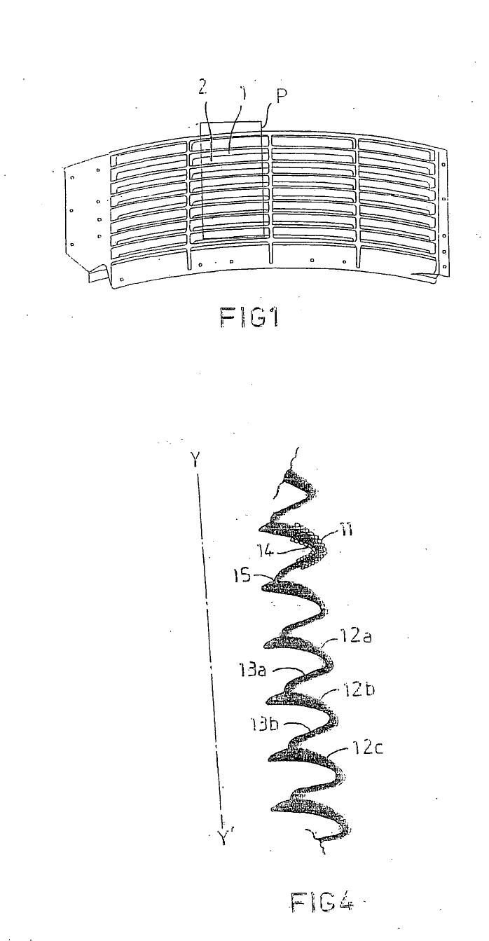

FIG. 1 shows a thrust reverser cascade;

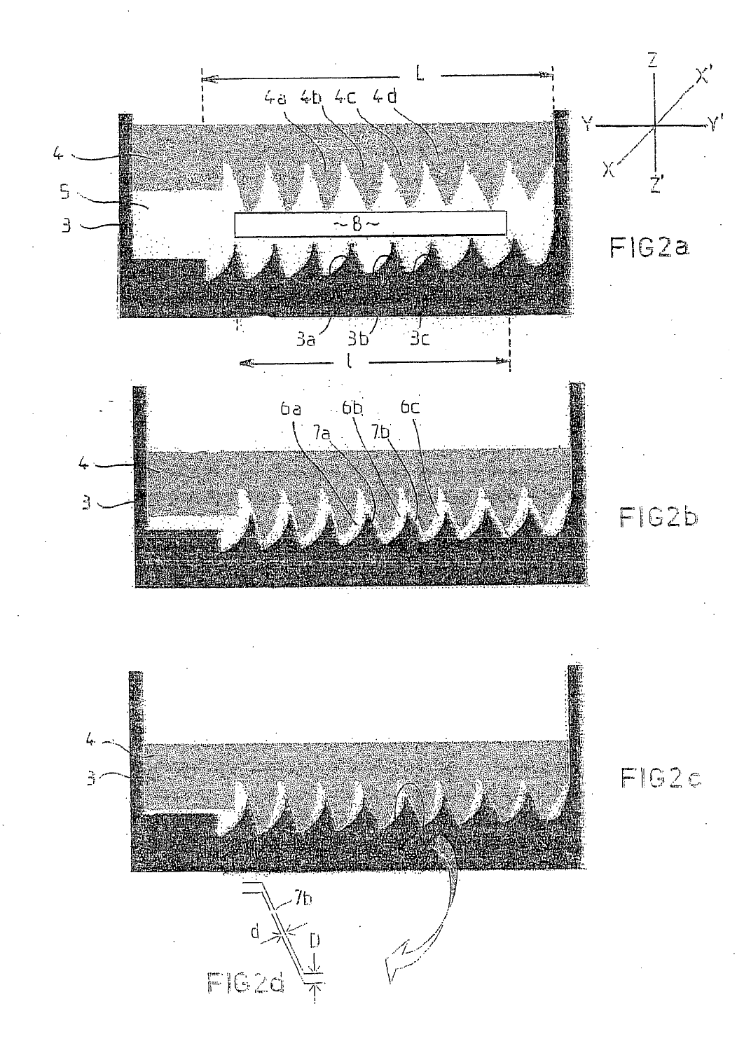

FIGS. 2a-2c illustrate the die-forming process according to the invention used to manufacture part of the product illustrated in FIG. 1, and FIG. 2d is an enlarged detail of FIG. 2c;

FIG. 3 is a diagram on a larger scale illustrating the orientation of the premix relative to the cavities of the die-forming tool of FIGS. 2a-2c;

FIG. 4 shows a cross section through part of the semifinished product after the step illustrated in FIG. 2c;

FIG. 5 shows a portion of a compressor rotor; and

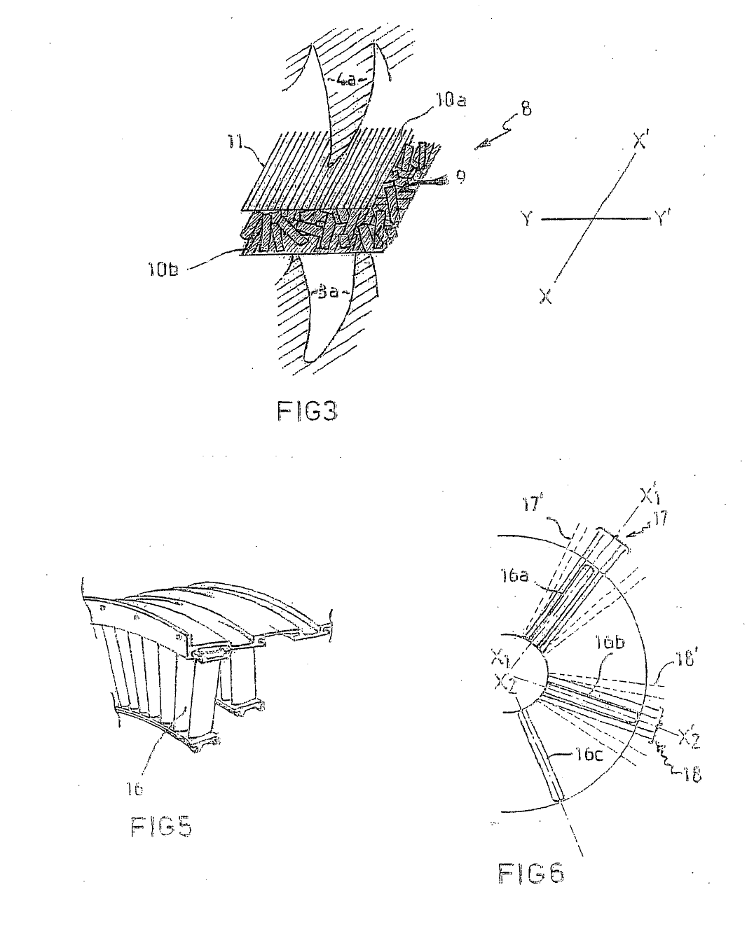

FIG. 6 is a diagram illustrating the orientation of the layers of unidirectional fibers of the premix in the case of the manufacture of blades or vanes of the compressor rotor portion of FIG. 5.

FIG. 1 illustrates one type of product, namely a thrust reverser cascade, part of which, such as that framed and indicated by P, may advantageously be manufactured according to the invention. However, of course in practice it is the entire cascade illustrated in FIG. 1 that is molded in a single operation.

Hereinafter, the part P will be called “the component” so as not to burden the description. As may be seen, this component comprises a series of parallel vanes 1 each having an aerodynamic profile and separated from each other by a gap 2.

FIGS. 2a-2c show schematically a die-forming tool for manufacturing the component P illustrated in FIG. 1.

This tool consists of a die 3 and a cover 4, which is mounted so as to slide vertically, in the Z-Z′ direction, in the matrix 3 and defines, with said die, a compression molding chamber 5. The opposed faces of the die and the cover have reliefs, 3a, 3b, 3c, etc. and 4a, 4b, 4c, 4d, etc. respectively, which are designed to interpenetrate and which, when they are coupled, define a series of cavities (FIG. 2b) such as 6a, 6b, 6c, etc. These cavities have a long dimension along the X-X′ direction and a small cross section in the (Y-Y′,Z-Z′) plane. The cavities 6a, 6b, 6c, etc. communicate with one another via passages 7a, 7b, etc., the faces determining said passages not being touching, even when the cover 4 is at the end of its travel in the die 3 (see FIG. 2d).

The shape and the arrangement of the cavities 6a, 6b, 6c etc. correspond to those of the vanes 1 of the component P of FIG. 1.

As may be seen in FIG. 2a, before die-forming, a premix sheet 8 is placed between the die 3 and the cover 4. This premix, as shown in FIG. 3, consists, in this example, of a fill material 9 sandwiched between two layers 10a and 10b of unidirectional fibers preimpregnated with a thermosetting resin. In practice, each layer advantageously consists of several individual plies oriented in the same manner and superposed. The volume ratio of unidirectional continuous fibers to filler material is substantially homogeneous throughout the premix. The premix 8 is oriented in such a way that its fibers 11 are parallel (along the X-X′ direction) to the long dimension of the cavities 6a, 6b, 6c, etc., it being understood that, under the effect of the die-forming, the fibers 11 cannot be extended, but they can be splayed out (in the Y-Y′ direction). This makes it possible to use a premix sheet 8 whose length 1 will be substantially equal to the length L of that region of the tool that defines the coverage of the component P to be obtained, whereas, after the deformation due to the die-forming, the length of the resulting sawtoothed surface will be considerably greater (see FIG. 4): these fibers 11 will be splayed apart and, if the fiber layers each consist of several superposed plies, as mentioned above, fibers of one ply may be accommodated between the splayed-out fibers of another ply in order to maintain the continuity of the layer despite its spread. Although FIG. 3 shows a premix 8 composed of a single unidirectional-fiber layer/fill material/unidirectional-fiber layer sandwich, one or more unidirectional-fiber layers could be sandwiched between two fill material layers, and/or several sandwiches could be superposed.

Returning to FIGS. 2a-2c, the premix sheet 8 is therefore placed in the tool where it undergoes a heating phase. The cover 4 is then lowered, creating pressure on the premix, which is forced to match the shape of the cavities 6a, 6b, 6c, etc. and of the passages 7a, 7b, etc. Owing to the thinness of the passages once the cover has come to the end of travel (see FIG. 2d in which, for example, d=3 to 5 tenths of an mm and D=1 mm), the premix located within the passages is forced to flow into the adjacent cavities, but in so doing it does not flow homogeneously—it is the fill material 9 that escapes, the fibers 11 themselves remaining trapped in the passages. It follows that the fill material is redistributed, with the result that, compared with the initial composition, the composition within the cavities 6a, 6b, 6c, etc. is richer in fill material 9 than the initial premix, whereas the composition within the passages 7a, 7b, etc. now consists practically only of continuous fibers 11.

The semifinished product resulting from step d) of the die-forming operation is as shown by the cross section in FIG. 4. This shows a succession of parallel elements 12a, 12b, 12c, etc. which correspond to the cavities 6a, 6b, 6c, etc. and are joined together by mesh grounds 13a, 13b, etc. which correspond to the passages 7a, 7b, etc. The parallel fibers 11 of the layers 10a, 10b included in the product have been shown in part of this figure in number, size and projecting position having nothing to do with reality. This is done merely to show the orientation of the fibers relative to that of the elements 12a, 12b, 12c, etc.

The subsequent step consists in removing the mesh grounds, such as 13a, 13b, etc., by cutting them off at the points 14 and 15, either by abrasive water jet or by machining.

The elements 12a, 12b, 12c, etc. are then like the vanes 1 of the component P of FIG. 1.

The process according to the invention is applicable to the manufacture of other series of juxtaposed elements separated by a space, for example radiating elements like the vanes 16 of a compressor rotor (see FIG. 5). In this case, it is necessary to employ a premix comprising several differently oriented layers of unidirectional continuous fibers so that, after die-forming, a component is obtained in which the elements 16 each have fibers oriented along their long dimension.

As is apparent from FIG. 6, in which several vanes 16a, 16b, 16c of the compressor rotor have been shown, the premix used comprises several layers of unidirectional continuous fibers, oriented differently as is illustrated by the fibers 17 and 18. More precisely, the vanes 16a, 16b have their long dimension oriented along the X₁-X₁′ and X₂-X₂′ axes respectively, and the layers 17 and 18 have, after die-forming, their fibers oriented parallel to these axes. In order to understand the drawing, in the illustration, the layers of unidirectional fibers extend beyond the end of the vanes, but in reality, of course, the premix in which these layers are included do not extend beyond the die-forming tool. Under the effect of the die-forming, the fibers 17 and 18 are splayed apart as indicated by the dotted lines at 17′, 18′, being adapted to the shape of the vanes and forming, between them, mesh grounds. As for the rest of the process, what was mentioned above in regard to the parallel vanes applies mutatis mutandis to the radiating vanes.

1-16. (canceled)

17. A process for manufacturing a series of juxtaposed elements separated from one another over at least part of their length, consisting:
a) in using, as raw material, a premix combining, in a substantially homogeneous volume ratio, on the one hand, at least one layer of resin-preimpregnated unidirectional continuous fibers and, on the other hand, a fill material;
b) in using, as equipment, a die-forming tool comprising a die and a cover defining together a series of cavities, the shape of which, which has a long dimension and a small cross section in the plane perpendicular to said long dimension, corresponds to that of the expected elements, said cavities communicating with one another via a passage provided between each pair of cavities, said passages having a volume such that, during the die-forming, most of the premix in the passages is forced to flow into the cavities;
c) in placing said premix in said tool in such a way that it affects said series of cavities and, by orienting it so that, in line with each cavity, there are fibers that extend along said long dimension and belonging to said at least one layer;
d) in die-forming said premix thus placed, resulting in the formation of a series of juxtaposed elements that are enriched with fill material compared with the volume ratio of the initial premix, which elements are joined together by webs of material, called here “mesh grounds”, which correspond to said passages and are depleted in fill material compared with the volume ratio of the initial premix; and
e) in eliminating said mesh grounds.

18. The process as claimed in claim 17, applied to the manufacture of a series of parallel juxtaposed elements, consisting in using a premix incorporating several layers of unidirectional continuous fibers, said layers making between them a substantially zero angle, and in that, in step c), the premix is oriented in such a way that the fibers of said layers are substantially parallel to the long dimension of the cavities of said series of cavities.

19. The process as claimed in claim 17, applied to the manufacture of a series of juxtaposed radiating elements, wherein consisting in using a premix incorporating several layers of unidirectional continuous fibers, at least some of said layers making between them an angle such that, in step c), there are, in line with each cavity, fibers extending along the long dimension of said cavity and belonging to at least one of said layers.

20. The process as claimed in claim 17, wherein the fibers of said layer or layers of unidirectional continuous fibers are capable of moving away from one another under the effect of the die-forming.

21. The process as claimed in claim 20, consisting in using a premix in which said layer or layers of unidirectional continuous fibers each consist of several superposed plies of such fibers oriented in the same direction and capable of moving away from one another under the effect of the die-forming, and in constraining, owing to the effect of the die-forming, the fibers of at least one of said plies to be accomodated between the splayed-out fibers of another of said plies.

22. The process as claimed in claim 17, wherein said layer or layers of unidirectional continuous fibers are produced from one or more plies having, individually, a thickness of between 1/10 mm and 1 mm.

23. The process as claimed in claim 17, wherein said fill material is in the form of granules, mats, filled resin or fragments of at least one ply of unidirectional preimpregnated fibers, or of a combination of them.

24. The process as claimed in claim 17, wherein said fill material is in the form of fragments of at least one ply of unidirectional preimpregnated fibers, or of a combination of such fragments with granules, mats or a filled resin, said fragments coming from a ply identical to a constituent ply of said at least one layer of unidirectional continuous fibers.

25. The process as claimed in claim 17, wherein said fill material is in the form of fragments of at least one ply of unidirectional preimpregnated fibers, or of a combination of such fragments with granules, mats or a filled resin, said fragments coming from a ply that differs from the constituent ply or plies of said at least one layer of unidirectional continuous fibers by its qualitative and/or quantitative composition and/or by its thickness.

26. The process as claimed in claim 17, wherein, before the die-forming, said premix is in the form of a sheet having a substantially constant thickness and the dimensions of which in the plane perpendicular to said thickness are substantially equal to the dimensions, in this same plane, of the region of the tool defining the coverage of the series of elements to be obtained.

27. The process as claimed in claim 17, wherein said mesh grounds are removed by water jet cutting.

28. The process as claimed in claim 17, wherein said mesh grounds are removed by machining.

29. A semifinished product resulting from the implementation of steps a)-d) of the process as claimed in claim 17, wherein the mesh grounds have a thickness of about 3/10 mm and 1 mm.

30. A structure incorporating elements resulting from the implementation of the process as claimed in claim 17, wherein said elements each have an aerodynamic profile.

31. A cascade for an aircraft engine thrust reverser, incorporating elements resulting from the implementation of the process as claimed in claim 17.

32. A compressor rotor, or part of such a rotor, incorporating elements resulting from the implementation of the process as claimed in claim 17.
